(19) United States
(12) Patent Application Publication
(10) Pub. No.: US 2021/0245393 A1
(43) Pub. Date: Aug. 12, 2021

(54) PROCESS FOR THE TREATMENT OF BARKS OF PLANT ORIGIN

(71) Applicant: Francesca NORI, Bracciano (Roma) (IT)

(72) Inventor: Francesca NORI, Bracciano (Roma) (IT)

(21) Appl. No.: 17/270,913

(22) PCT Filed: Sep. 19, 2019
(86) PCT No.: PCT/IB2019/057912

§ 371 Date: Feb. 24, 2021

(30) Foreign Application Priority Data
Sep. 19, 2018 (IR) 102018000008714

(51) Int. Cl. B27K 9/00

(52) U.S. Cl. CPC B27K 9/00

(57) ABSTRACT

The present invention relates to a process for the treatment of vegetable barks, in particular of pineapple barks or melon barks, which allows to obtain a product of a completely vegetable nature, which also preserves the aesthetic appearance of the starting vegetable barks having, however, physical and mechanical characteristics greatly improved with respect to the first product, high stability and resistance so as to be able to use the material resulting from the treatment for the most varied applications, in the fashion sector, in particular for making and / or decorating garments and leather goods, in the furniture and design sector, and in any other related fields.

### DESCRI PTION

### Field of the Invention

The present invention relates in general to the field of the treatment of materials, and more particularly, it refers to a process for the treatment of barks of plant origin, in particular of pineapple or melon barks, which allows maintenance of the original appearance of the barks improving their physical and mechanical characteristics, making them stable and rot-proof for the most diverse applications.

### State of the Art

Recently, consumers' demand has increased for products of plant origin not only in the food sector, but also in other sectors, including the clothing and fashion accessories sector. This request does not refer only to traditional textile products based on cotton, linen or hemp, but also to materials completely unknown until now for use in these fields, such as soy-based textile products or materials obtained from vegetable waste.

Because of the spread of an increasingly strong animalist sensitivity, moreover, if we think in particular to the leather goods sector, the replacement of traditional leather with products of plant origin presents, in addition to guaranteeing the naturalness and ecology of the product, the further attraction for the consumer of being cruelty-free, that is to avoid acts of cruelty on animals for the sole purpose of obtaining their skin.

However, the products made with these materials are always required to have a pleasing aesthetic appearance to which the consumer is apparently not willing to give up, and also higher quality performances, in addition to a more or less high workability and resistance depending on the application and destination of use. In particular, in the case of ecological leathers, the physical and mechanical characteristics required to the material are particularly stringent, since the material must guarantee sufficient strength and resistance to be able to be sewn for example, or in any case joint with portions of the same or of different materials, to manufacture the finished product in the form of a bag, purse, belt, and the like.

In order to aspire to obtain a material with such characteristics, the starting plant material clearly has to be submitted to treatments which must in their turn guarantee the desired ecology not only of the product following the treatment, but also of the process itself and of the reagents and solvents used to make it.

To date, some attempts have been made to meet the aforementioned market demands, creating materials for use in the clothing and fashion accessories sector starting from plant products, including waste products or in any case fruit, vegetables, mushrooms, etc. So far, however, as far as the Applicant is aware of, such attempts have been aimed at obtaining a material whose natural composition and plant origin could be guaranteed, without however paying attention to its characteristics of robustness and resistance, required to create for example a bag. Or, to obtain these characteristics of robustness and solidity, the attempts made so far have involved treatments which, to obtain the required resistance, completely transformed the structure of the starting material and also inevitably any recall to its original aesthetic appearance.

For these reasons, to date, it is still recognised the need to have an ecological treatment process of products of plant origin, capable of providing a high quality treated material, with the stability and resistance necessary to make it suitable for use in the clothing and fashion accessories sector, while maintaining the original appearance of the original starting product.

### SUMMARY OF THE INVENTION

Now the Applicant has found that barks of plant origin, such as for example pineapple or melon barks, if subjected to a process of treatment with aqueous solutions of an aldehyde agent described in the following, result in a robust and stable, rot-proof material, which also maintains the aesthetic appearance of the starting product.

Advantageously all the reagents and solvents used in this process of treatment are neither toxic for people nor harmful for the environment, therefore they do not create any problems related to the safety of use and to health of the operators who handle them, nor they leave traces or toxic residues in the treated product.

Subject of the present invention is therefore a process for treating barks of plant origin as defined in the first of the appended claims.

A treated material obtainable from such process, its use as a substitute for animal-based leather and an article made with it, as defined in the independent claims 8, 9 and 10 herein attached, represent a further subject of the present invention.

Other important features of the process for treating barks of plant origin, of the so treated material and of its use, and of the articles made with the material according to the invention are set forth in the following detailed description.

### BRIEF DESCRIPTION OF THE FIGURES

FIG. 1: sample of pineapple bark, treated with the process of the invention according to the following Example 1.

FIG. 2: sample of pineapple bark, air dried without the treatment of the invention according to the following comparison Example 2.

### DETAILED DESCRIPTION OF THE INVENTION

In the following description, unless otherwise specified, percentage quantities are expressed as percentages by weight with respect to the total weight of the composition comprising them.

The Applicant has surprisingly found that barks of plant origin, when immersed in a bath comprising an aqueous solution of an agent of treatment selected from the group consisting of glutaraldehyde, acetaldehyde, glyoxal and mixtures thereof, acquire improved characteristics of hydrothermal and mechanical resistance with respect to the starting product, and a much greater stability, while maintaining the aesthetic appearance of the starting barks, with no changes. In addition to a high resistance and stability, the plant material obtainable with the present process has also proved to be rot-proof, contrary to the starting plant product.

Glutaraldehyde is a low molecular weight aliphatic dialdehyde, with formula:

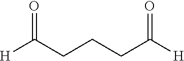

It is a water-soluble compound, whose aqueous solutions are stable and poorly volatile. It is also a widely used commercial product, whose main uses are:

in the health sector where glutaraldehyde is used as a disinfectant in the form of a diluted aqueous solution (conc. 2-5% by weight), available in different commercial formulations; and

in the tanning industry, where glutaraldehyde is used as a tanning and pre-tanning agent for animal skin, generally in the form of a concentrated aqueous solution (conc. 25-50% by weight).

Acetaldehyde is the simplest aliphatic aldehyde, with lower molecular weight, of formula

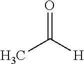

At room temperature, it is a colourless liquid, widely used in industrial organic synthesis.

Similarly in the form of colourless liquid at room temperature, the glyoxal is the simplest dialdehyde, with formula

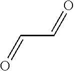

Glyoxal is already widely used in the paper, textile and pharmaceutical industries, where it is used as a precursor in the synthesis of organic compounds.

In a preferred embodiment of the present process, glutaraldehyde is used as a treatment agent.

This result was completely unexpected in nature, composition and consistency of barks of plant origin, completely different for example from any type of animal-based leather. Moreover, the aesthetic aspect of the starting barks of plant origin is completely preserved even when the immersion phase is such that it led the aldehyde treatment agent to penetrate inside and throughout the section of the bark. This penetration into the interior of the bark is a preferred condition of the process of this invention since it is more effective in improving the strength and stability of the final material, and it is a condition which can be obtained, for example by subjecting the immersed barks in the stirring bath, preferably mild, and / or prolonging the immersion for a sufficiently long time. In one aspect of the present process, the barks immersion phase can last for between 1 hour and 3 days. Optimal results on pineapple barks were observed by keeping the barks immersed in the bath for about 2 days under mild agitation. For different barks, the optimal times with and without agitation can be easily determined by any expert with ordinary skills in the sector within the conditions described above.

As described in detail in the experimental part that follows, this has been observed in particular for pineapple barks, barks of plant origin with a particularly original appearance, formed by plaques fused between them, which are completely preserved in the material after treatment with the process of the Invention. The same has been found by subjecting the process of the invention to melon barks, also chosen for their particular appearance, characterized by more or less evident longitudinal flange and by a more or less thick and evident reticulation. It is understood that pineapple and melon barks are mentioned herein by way of a non-limiting example, and other barks of plant origin, in particular those barks which are original due to their aesthetic appearance, do fall within the scope of the present invention. The material resulting from the present treatment is particularly original and attractive by appearance, and at the same time has acquired a stability and a hydrothermal and mechanical resistance completely unknown to the untreated pineapple or melon barks, so that, with the barks treated according to the invention, complex articles such as bags and pouches have been manufactured, by sewing parts of material previously cut according to models. More in general, for the barks of plant origin, the present process has provided a surprising effect of improving their functional features and performance giving rise to a high performance finished material from a physical and mechanical point of view, rot-proof over time and endowed with high stability and hydrothermal resistance. Thanks to these characteristics, the material thus obtained can be successfully used not only in the fashion sector, in particular for making and / or decorating clothing and leather goods, but also in the furniture and design sector, and in other similar fields.

Within the scope of the present invention, by “aqueous solution of an agent of treatment” which, as stated above, is selected from the group consisting of glutaraldehyde, acetaldehyde, glyoxal and mixtures thereof, it is preferably meant an aqueous solution having a concentration of the aforementioned agent of treatment >2% by weight, more preferably an aqueous solution of the aforementioned agent having a concentration equal to about 2.5% by weight with respect to the total weight of the solution.

The bath in the immersion step of the present process can further comprise, in addition to water and agent of treatment, also any additives, dyes, flavours and agents commonly used and acceptable in the field, in particular products derived from sugars and/or from proteic substances, such as moisture correctors and fillers. These latter additives, i.e. products derived from sugars and protein substances respectively having corrective action of humidity and filling action on the internal structure of the material, have proved effective in further improving the stability and product characteristics of the finished material in the present treatment process.

According to an embodiment of the process of the invention, the bath in the immersion step consists of an aqueous solution of the aforementioned agent of treatment with one or more of the aforementioned derivatives of sugars and proteic substances. According to a further embodiment of the process of the invention, the bath in the immersion step consists of an aqueous solution of agent of treatment without any further additives, agents or any substances.

The aforementioned additives may be added ab initio to the immersion bath or may be added thereafter, after the barks of plant origin have already spent a certain period of time within the bath. This addition can be simultaneous or, preferably, in sequence, keeping the barks immersed for a certain period of time after each addition, so as to facilitate the penetration into the internal structure of the various substances present in the bath.

In one aspect of the present process, the bath in the immersion step has a pH of between about 2 and about 8, and it is preferably about 3.

In the present process, both the immersion step and the possible pre-treatment step are for example carried out at a temperature ranging from about 5° C. and about 45° C.

According to a preferred embodiment of the present process, the step of immersing the barks of plant origin in a bath comprising an aqueous solution of the aldehyde agent of treatment is preceded by a step of pre-treatment of the barks of plant origin in an aqueous solution comprising at least a neutral salt, for example NaCl, and an acid, e.g. formic acid.

Thanks to its characteristics, in particular to their water-solubility and stability in aqueous solution without any other solvents or diluents, the aldehyde agents of the invention represent an ideal product for use in an ecological process, as that of the present invention is. Moreover, the present process, in its simplicity and safety, allows to significantly improve the characteristics of the starting products while preserving the aesthetic aspect too, as opposed to known processes in which the processing of the starting plant product is so strong that it completely transforms the appearance of the plant product, flattening it over that of any ecological leather.

The invention is described in the following by means of examples without, however, being limited thereto, but it is understood that the amounts and percentages of the reagents described can vary, as well as the type of reactors and more generally the type of conditions used while remaining within the range of the present invention.

### EXAMPLE 1

Starting from 6 fresh pineapples their respective bark has been obtained.

A pre-treatment bath with water and NaCl was also prepared, added in such a quantity to reach a density of about 8 Bè. It was also added to the salt solution 0.2 g/l of an antibacterial agent based on dithiocarbammate and 2 g/l of formic acid (approximately 72% conc.).

The so composed bath was poured into a cylindrical container equipped with a mechanical stirrer and subjected to gentle stirring until all the components were mixed. At this point the pineapple barks were immersed in the bath and the mild stirring of the bath continued until a pH equal to about 3 was reached. Once this pre-treatment phase was concluded, 0.2 g/l of formic acid and 25 g/l of glutaraldehyde (aqueous solution at about 50% concentration) were added to the bath and mild agitation of the immersed barks is continued for 2 days. After this period of time, the bath was progressively basified until it reached a pH of about 7 by addition of sodium bicarbonate, then a proteinaceous substance obtained from the hydrolysis of animal collagen was added and mild agitation was continued for further 6 hours.

The barks so treated were taken from the container and completely immersed in a water bath in a new container. Then glycerin was added in a quantity of 100 g/l and a mild agitation was maintained for 1 day.

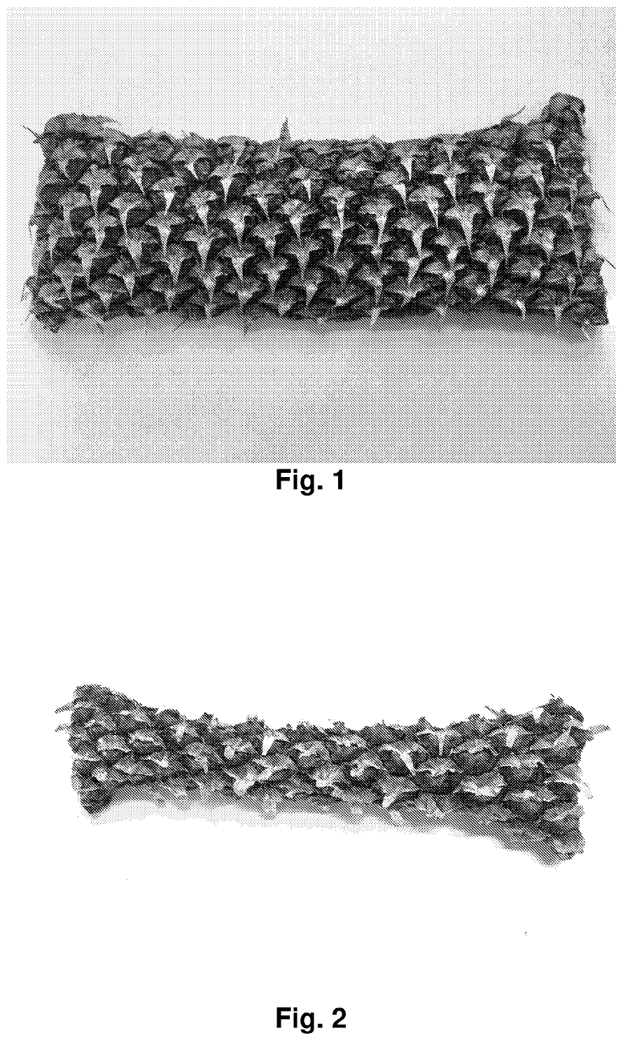

The barks treated as described above, once taken from this bath, were subjected to air drying. FIG. 1 shows one of the pineapple barks treated as described above.

These barks treated with the invention process have been used, instead of animal-based leather, to make some leather goods. The barks treated as described above showed a remarkable ease in cutting and sewing, high mechanical strength and stability over time; they also conferred considerable strength to the finished article. In particular, no detachment of the blocks that make up the structure of the pineapple bark has been observed. At the same time, as can be seen from FIG. 1, the aesthetic and dimensional characteristics of the starting bark were maintained in full: in particular, the colouring of the starting bark was exactly maintained after the treatment, as well as the appearance of the individual blocks.

### EXAMPLE 2

### Comparison

Starting from a fruit of the same size and degree of maturation of the samples used in Example 1 above, a bark was obtained having the same dimensions as the barks of Example 1.

The bark of the fresh fruit was then subjected, without any treatment, to air drying for the same time and in parallel with the barks of Example 1, treated with the process of the invention. The result, comparable to that obtained for any air-dried vegetable peel, is visible in the annexed FIG. 2.

As can be seen from the figure, the size of the sample is greatly reduced compared to the sample in FIG. 1, the colouring appeared much duller and the shape of the blocks was damaged. Furthermore, once subjected to torsion or other mechanical stresses, this sample broke and, a few days after the start of the experiment, the onset of mold was also observed.

### EXAMPLE 3

The same treatment described above in Example 1 for pineapple barks was also carried out on melon barks made from fresh fruit, after having eliminated the pulp, and using the same experimental treatment conditions described above for pineapple barks. The results were quite similar: the melon barks treated with the invention process showed in particular a high mechanical strength and stability, in addition to a robustness that allowed precision cutting and sewing to make complex articles. The aesthetic characteristics of the starting bark, characterized by an original relief grid and longitudinal ribs, were instead perfectly maintained after the treatment. In addition to the morphology of the natural bark, the original colour was also maintained.

The present invention has been so far described with reference to a preferred embodiment thereof. It is to be understood that there may be other embodiments which refer to the same inventive core, as defined by the scope of protection of the claims set forth below.

1. A process for the treatment of barks of plant origin, comprising of immersing said barks in a bath comprising an aqueous solution of an agent of treatment selected from the group consisting of glutaraldehyde, acetaldehyde, glyoxal and mixtures thereof.

2. The process according to claim 1, wherein sugar derived products and/or protein substances are added to said bath.

3. The process according to claim 1, wherein said barks of plant origin are kept dipped into said bath under stirring for a time ranging between 1 hour and 3 days.

4. The process according to claim 1, wherein said aqueous solution has a concentration of said agent of treatment higher than 2% by weight with respect of the total weight of the solution.

5. The process according to claim 1, wherein said bath has a pH ranging between 2 and 8.

6. The process according to claim 1, further comprising before said step of immersion, a pre-treatment step of said barks of plant origin in an aqueous solution comprising a neutral salt and an acid.

7. The process according to claim 1, wherein said agent of treatment is glutaraldehyde.

8. A material of plant origin obtainable with the process of treatment of barks of plant origin as defined in claim 1, said material having the same aesthetic appearance of the barks of plant origin before being subjected to the process of treatment and improved stability and hydrothermal and mechanical resistance.

9. (canceled)

10. An article manufactured, fully or in part, with the material treated by the process as defined in claim 1.

11. The process according to claim 1, wherein said barks of plant origin are pineapple barks or melon barks.
